(19) United States
(12) Patent Application Publication
(10) Pub. No.: US 2015/0191375 A1
(43) Pub. Date: Jul. 9, 2015

(54) Device For Transforming Soluble Phosphates Found In Washing Machine Wastewater Into Insoluble Form By Precipitation

(71) Applicant: Thomas Adam Leahy, Circleville, NY (US)

(72) Inventor: Thomas Adam Leahy, Circleville, NY (US)

(21) Appl. No.: 14/149,982

(22) Filed: Jan. 8, 2014

(51) Int. Cl. C02F 1/52

(52) U.S. Cl. CPC C02F 1/5245

(57) ABSTRACT

A device to transform soluble phosphates found in washing machine wastewater into an insoluble state using a two chamber, low-pressure environment device to mix dosing chemical with wastewater discharge causing a precipitation reaction.

### BACKGROUND OF THE INVENTION

1. Field of the Invention

Embodiments of the present invention relate to an unrestricted flow, low-pressure environment, two chamber device, systems and methods, for transforming soluble phosphates in washing machine wastewater into insoluble form by precipitation.

2. Description of Related Art

A precipitation reaction is a common type of chemical reaction in solution chemistry. Basically, two or more solutions are combined resulting in a reaction that produces an insoluble product, a precipitate. Typically, as here, these types of reactions involve ionic compounds in aqueous solution. The precipitation reaction is said to occur because of the strong attractive forces certain ions have for each other. These ions combine and fall out of solution in the formation of a solid.

People and businesses wash their clothing and dishes by hand or with the aid of a laundry washing machine or dishwashing machine. To affect the best cleaning results, a detergent being part of a complex formula of many ingredients is added to the wash cycle. One of the most effective chemical ingredients known to science and consumers worldwide being added to detergents is a complex chemical phosphate named sodium tripolyphosphate or STPP, having the chemical formula Na₅P₃O₁₀. This chemical phosphate or “builder” as the term is used in the art sequesters calcium, magnesium, and other mineral and iron ions found in hard water making the water substantially softer. Soft wash water has the advantage of greatly enhancing a detergent's ability to develop frothy suds being an important part of the cleaning process. Suds act like a transport system by attracting and encapsulating dirt, making elimination of dirt in the rinse cycle more efficient.

Additionally, STPP has the ability to break the bond or molecular physical attraction between fabrics and dirt or dishes and food particles thereby making laundry and dishes cleaner. Further, STPP has the ability to reduce the amount of food particles or dirt re-depositing back onto fabrics or dishes prior to initiation of the rinse cycle assuring a superior cleaning result. Finally, even at locations where water quality is naturally soft or the water has been pre-treated, use of STPP is still very desirable because one source of water hardness results from dirt and grime being dissolved off clothes in the wash cycle and such hardness needs to be continually rebalanced.

STPP has been added to detergents for several decades, making detergents powerful and effective cleaning agents. It has been discovered however, that STPP has a negative environmental impact being hypertrophication that is an ecosystem's response to the addition of soluble phosphates, an elemental nutrient, to an aquatic system. This occurs in one instance, when untreated or undertreated wastewater containing soluble phosphates originating from laundry washing machines or dish washing machines is discharged into lakes, streams and other waterways. One example is the “bloom” or great increase of phytoplankton in a water body as a response to increased levels of soluble phosphate nutrients. Negative environmental effects also include hypoxia being the depletion of oxygen in the water, which induces reductions in specific fish and other animal populations. Eutrophication generally promotes excessive plant growth and decay, favoring simple algae and plankton over other more complicated plants causing a severe reduction in water quality.

As a result, over the years, use of STPP in detergents has been severely limited, carefully regulated, or completely banned by law in various states within United States and in many other industrialized nations. Consumers and businesses worldwide would enjoy unrestricted use of STPP to greatly enhance their detergent's effectiveness and their overall washing experience, as there is no comparable product available in the marketplace with such exceptional detergent enhancing properties. However, people and businesses are generally unwilling to accept the environmental consequences associated with such unrestricted soluble phosphate use. As such, they would welcome a viable method and system to prevent or substantially reduce such environmental consequence.

Treatments of wash water in conjunction with automatic laundry washing machines or dishwashers have been effected in the past. However, most treatments involved softening of the water or adjusting its pH prior to use, so to avoid the precipitation of lime soaps or other insoluble products in the washing solution. Such precipitate would otherwise deposit on the materials being washed, giving them an objectionable film. In other cases, wastewater discharge has been treated to remove dirt and suspended materials and then has been reused. In such processes, the still useful phosphate is maintained in soluble form. Before the present invention, there was never provided a simple, effective, low-pressure environment, unrestricted flow dosing device for transforming soluble phosphates into insoluble form in residential and commercial laundry and dishwasher wastewater discharge.

I cite however U.S. Pat. No. 3,954,403 filed Oct. 1, 1973 being an effort by that inventor, to produce a similar result as the present invention using a completely different scientific principle apparatus being a high pressure environment, highly restricted flow, Venturi effect apparatus (Page 5/lines 46-52). The apparatus intended to create a vacuum causing dosing chemical to be drawn up a supply tube (Page 5/lines 56-61) to mix with soluble phosphates in the wastewater discharge stream within the Venturi apparatus.

### SUMMARY OF THE INVENTION

Aspects and embodiments described herein are directed to a two chamber, unrestricted flow, low-pressure environment, chemical dosing device, systems and methods, for use with residential and commercial laundry washing machines and dish washing machines.

The device provides a system to transform sodium tripolyphosphate (STPP) being a water soluble phosphate and other water soluble phosphates into an insoluble state. In their insoluble states, STPP and other water-soluble phosphates cannot be absorbed in an ecosystem by algae, phytoplankton or other aquatic plants. Thus the present device will substantially reduce or completely eliminate the environmental impact associated with eutrophication in lakes, streams and other waterways caused by washing machine wastewater discharge.

### BRIEF DESCRIPTION OF DRAWINGS

The systems and methods described herein can be better understood with reference to the following drawings. The components in the drawings are not necessarily drawn to scale, emphasis instead being placed upon clearly illustrating the principles of the present disclosure. In the drawings, like reference numerals designate corresponding parts throughout the several views.

FIG. 1 illustrates a mechanically actavated embodiment of the present invention.

FIG. 2 illustrates an electromechanically activated embodiment of the present invention.

### DETAILED DESCRIPTION OF THE INVENTION

Disclosed is a two chamber, unrestricted flow, low-pressure environment chemical dosing device designed and engineered to introduce a measured amount of dosing chemical into the wastewater discharge stream of residential and commercial laundry washing machines and dish washing machines. The dosing chemicals include such chemicals as calcium chloride, or alternatively calcium hydroxide, aluminum sulfate, or any other chemicals, or combinations of these and other chemicals, that are able to exhibit similar chemical precipitation reactions when mixed with soluble phosphates previously added to the washing cycle to enhance detergent characteristics.

This dosing introduction will cause a chemical precipitation reaction to occur that will transform a soluble phosphate such as sodium tripolyphosphate (STPP) or tetrasodium pyrophosphate, or other monobasic, dibasic, or tribasic sodium phosphates, which were added to the detergent in the washing cycle into an insoluble state. By effectively transforming STPP or other soluble phosphates into an insoluble state at the source, untreated or undertreated washing machine wastewater discharged into rivers, lakes and other waterways from municipal or other managed water treatment facilities, cannot contribute to the effects of eutrophication as aquatic plants are unable to absorb nutrients from phosphates that have been transformed into an insoluble state.

The mixing of these chemicals causing a chemical precipitation reaction can be effected by different methods. This includes simple hand mixing of the wastewater discharge volume and dosing chemical in a separate large tub. Alternatively, the present invention's two chamber, unrestricted flow, low-pressure environment dosing device, can affect this process automatically via a method that is the simplest, most efficient and cost effective approach without the many limitations of other commercial chemical dosing devices or processes.

The first chamber of the present device is preferably a pipe section with approximately a 1 inch inside diameter and approximately 6-12 inches in length, of sufficient inside dimension to reduce any material wastewater flow backpressure on the washing machine. This first pipe section is a wastewater transit corridor, dosing chemical premixing chamber, and superstructure to attach various device components to affect proper operation.

The first chamber then connects to a second pipe chamber which is preferably a static mixing device approximately 8-16 inches in length and approximately 2-4 inches in diameter, which also serves as a transit corridor and has sufficient inside dimension to reduce any material wastewater flow backpressure on the washing machine. Such static mixing device is designed and engineered to enhance final intermixing of dosing chemical and partially soluble phosphates that are in transit to a structure's sewer drainpipe or further treatment, by wastewater traveling through channels and impacting stationary baffles contained within the static mixer housing causing radical fluid turbidity.

By using a two chamber unrestricted flow, low-pressure environment device, the present invention is able to use a quill type injector in the premixing first chamber to introduce dosing solution into the center of the wastewater stream, being according to well-settled science, the ideal placement when enhanced chemical intermixing is desired. Further, the present invention incorporates a static mixing chamber placed after the quill injector that assures opportunity for a precipitation reaction to occur based upon radical fluid turbidity. Finally, as the present invention performs in a low-pressure environment, there is less backpressure on the washing machine, which backpressure may result in explosive catastrophic failure of the water pump, connecting hoses or other machine components.

### First Embodiment

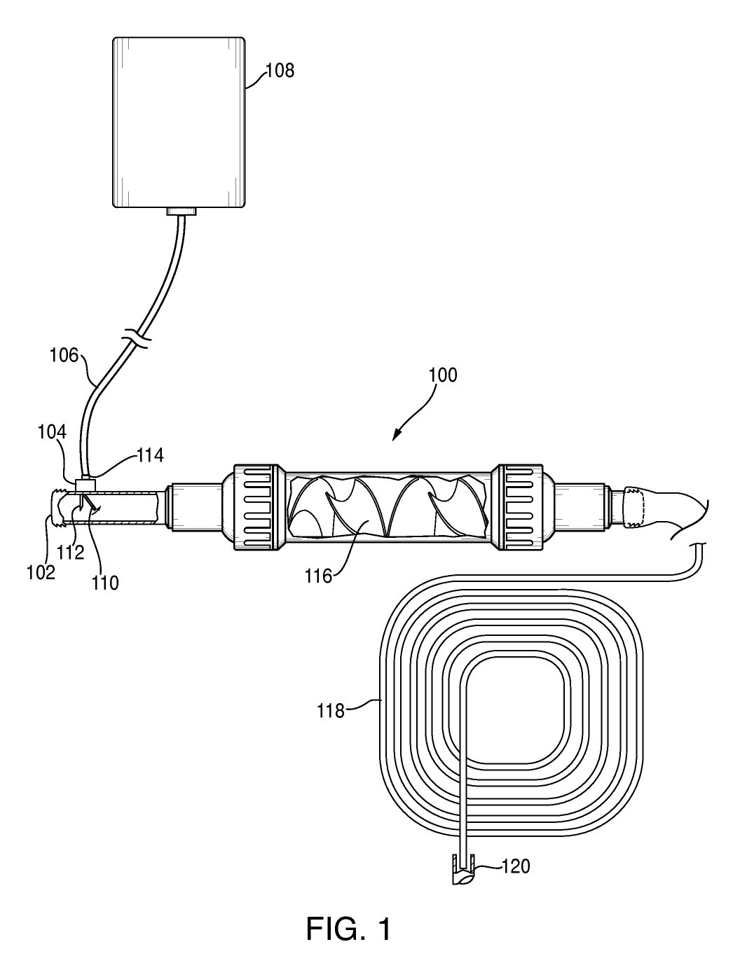

In embodiment one, as shown in FIG. 1, the washing machine's wastewater discharge hose is connected to a hose barb 102 on the input end of the first chamber of a two chamber, unrestricted flow, low-pressure environment dosing device 100 which is preferably part of and incorporated into a simple pipe section with an inside diameter of approximately 1 inch, or of sufficient inside dimension in each application to reduce any material wastewater flow backpressure on the washing machine and approximately 6-12 inches in length.

The volume of washing machine wastewater discharge passes into and through the first chamber of the dosing device, pushing against a mechanical actuating lever 110 of a manual valve assembly 104 attached through the wall of the chamber. This opens a normally closed port therein between the inside low-pressure chamber of the dosing device 100 and the supply tube 106 of a supply of dosing chemical, in this embodiment an elevated storage container 108 of dosing chemical. The container preferably has a capacity of approximately five gallons, although it will be understood that other sized containers are possible.

The storage container 108 is preferably secured approximately 2 feet above the device 100, allowing a measured amount of dosing chemical, preferably approximately ½ gallon per minute, to flow by gravity through an approximately ⅛ inch inside diameter plastic supply hose 106 approximately 4-6 feet in length.

The stored dosing chemical is preferably calcium chloride or alternatively calcium hydroxide, aluminum sulfate, or any other chemicals that exhibit similar precipitation reactions, when mixed with soluble phosphates present in the wastewater discharge stream that were previously added in the washing cycle to enhance a detergent's effectiveness.

Thereafter, the dosing chemical enters the valve assembly's port 104 transiting into the wastewater stream through a quill type injector 112 that is positioned below the valve assembly inside the low-pressure chamber of the device 100, depositing the dosing chemical into the center of the wastewater discharge stream. The manual valve assembly 104 also incorporates a manual purge feature 114 to prime the chemical storage dosing supply tube by causing dosing chemical to flow through from the supply to expel air when necessary at first start-up, or at any time thereafter if the supply container runs dry.

Thereafter, the continued admixing of the dosing chemical and partially soluble phosphates contained in the wastewater discharge is effected by the wastewater stream entering the second chamber of the dosing device 100 that is a static mixing device.

The static mixing device is of sufficient inside dimension to reduce any material wastewater flow backpressure on the washing machine, preferably approximately 8-16 inches in length and approximately 2-4 inches in diameter. The static mixing device is designed and engineered to create radical fluid turbidity within the device 100 by directing wastewater through channels to impact stationary baffles 116 contained within the housing, thus enhancing intermixing of dosing chemical and partially soluble phosphates. Thereafter, the wastewater stream exits the static mixing chamber of the dosing device, 100 where partially soluble phosphates have been insolubilized.

Upon exiting, the wastewater stream is preferably detained for a period of time by routing the wastewater stream through a detention volume. In this embodiment the detention volume is a coiled length of flexible hose, 118 preferably approximately 25-50 feet in length to assure adequate detention time for the precipitation reaction to mature prior to wastewater being discharged into a structure's sewer drainpipe, 120 or otherwise further treated. The inside diameter of the detention volume should be sufficient to reduce any material wastewater flow backpressure on the washing machine, for example a diameter of approximately 1 inch is preferred.

### Second Embodiment

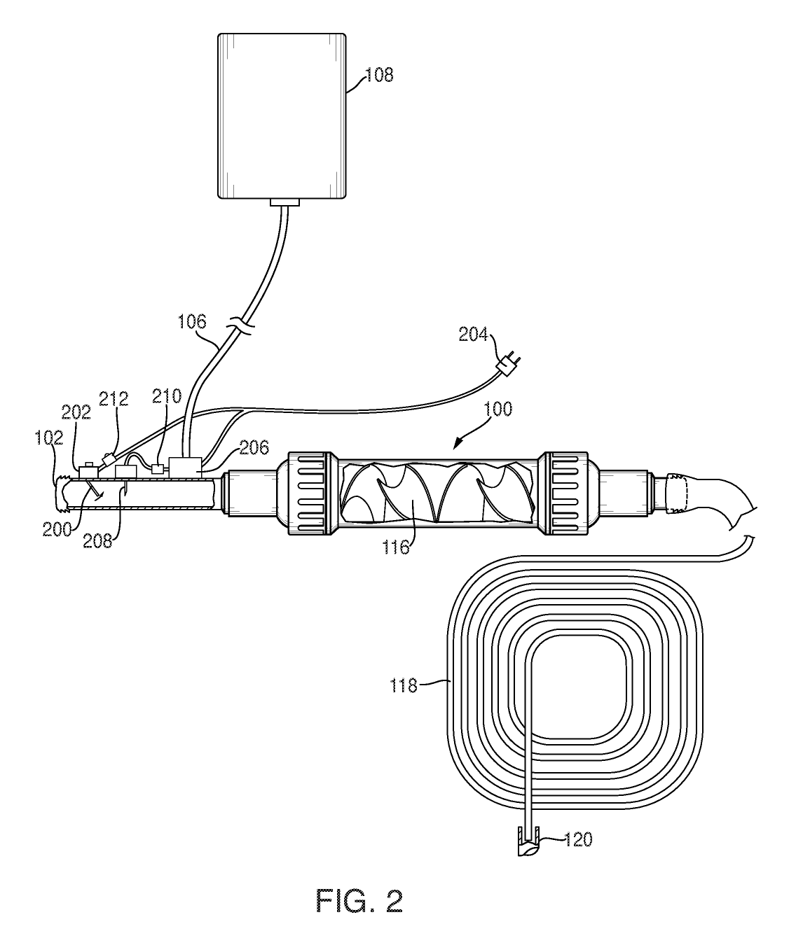

In embodiment two, as shown in FIG. 2, the dosing chemical process is induced by the use of electrically energized components that replace the manual valve assembly 104 and gravity fed dosing supply functions of embodiment one.

In this embodiment, the washing machine's wastewater discharge hose is connected to a hose barb 102 on the input end of the first chamber of a two chamber, unrestricted flow, low-pressure environment dosing device 100 which is preferably part of and incorporated into a simple pipe section with an inside diameter of approximately 1 inch, or of sufficient inside dimension in each application to reduce any material wastewater flow backpressure on the washing machine and approximately 6-12 inches in length.

The volume of washing machine wastewater discharge passes into and through the first chamber of the dosing device 100 pushing against the actuating lever 200 of a normally open type electric flow switch, 202 or flowing past a sensing element of an electronic flow sensor, 202 attached to the wall of the pipe section. The switch or sensor 202 then closes an electrical circuit between a power supply 204 and a water pump 206 that is placed inline on the dosing chemical storage tank supply tube, 106 between the storage tank and dosing device.

Thereafter, the electric water pump 206 facilitates chemical dosing flow through the supply tube 106 to a quill type injector, 208 transporting and depositing the dosing chemical into the center of the wastewater discharge stream under pressure. A check valve 210 may be provided, positioned on or near the first chamber of the dosing device 100 to prevent dosing chemical from entering the dosing device 100 from the storage container 108 when not intended.

The storage container preferably has a capacity of approximately five gallons, although it will be understood that other sized containers are possible. The storage container 108 is preferably placed near the dosing device, 100 allowing a measured amount of dosing chemical, preferably approximately ½ gallon per minute, to be pumped by the pump 206 through an approximately ⅛ inch inside diameter plastic supply hose 106 approximately 6-8 feet in length.

The stored dosing chemical is preferably calcium chloride or alternatively calcium hydroxide, aluminum sulfate, or any other chemicals that exhibit similar precipitation reactions, when mixed with soluble phosphates present in the wastewater discharge stream that were previously added in the washing cycle to enhance a detergent's effectiveness.

The electric flow switch or flow sensor 202 preferably incorporates an electric purge feature in the form of an additional switch 212 wired in parallel that activates dosing flow on demand by energizing the water pump 206 to prime the chemical dosing supply tube 106 by supplying dosing chemical to expel air from the tube when necessary, for example at first start-up or at anytime thereafter if the supply container runs dry.

Thereafter, the continued admixing of the dosing chemical and partially soluble phosphates contained in the wastewater discharge is effected by the wastewater stream entering the second chamber of the dosing device 100 that is a static mixing device.

The static mixing device is of sufficient inside dimension to reduce any material wastewater flow backpressure on the washing machine, preferably approximately 8-16 inches in length and approximately 2-4 inches in diameter. The static mixing device is designed and engineered to create radical fluid turbidity within the device by directing wastewater through channels to impact stationary baffles 116 contained within the housing, thus enhancing intermixing of dosing chemical and partially soluble phosphates. Thereafter, the wastewater stream exits the static mixing chamber of the dosing device, 100 where partially soluble phosphates have been insolubilized.

Upon exiting, the wastewater stream is preferably detained for a period of time by routing the wastewater stream through a detention volume. In this embodiment the detention volume is a coiled length of flexible hose, 118 preferably approximately 25-50 feet in length to assure adequate detention time for the precipitation reaction to mature prior to wastewater being discharged into a structure's sewer drainpipe, 120 or otherwise further treated. The inside diameter of the detention volume should be sufficient to reduce any material wastewater flow backpressure on the washing machine, for example a diameter of approximately 1 inch is preferred.

Embodiments disclosed herein may be combined with other embodiments in any manner consistent with at least one of the principles disclosed herein, and references to “an embodiment” “some embodiments” “an alternative embodiment” “various embodiments” “one embodiment” or the like are not necessarily mutually exclusive and are intended to indicate that a particular feature, structure, or characteristic described may be included in at least one embodiment. The appearances of such terms herein are not necessarily all referring to the same embodiment.

Having described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the descriptions and drawings are by way of example only.

The embodiments of the present invention in which an exclusive property or privilege is claimed are defined as follows;

What is claimed:

1. A chemical dosing device for treating wastewater from a water discharge hose of a washing machine, comprising:
a) a first chamber having a first end, a second end and a length therebetween, an input at a first end for coupling to the water discharge hose, a dosing chemical input, and an output, the first chamber having an inside dimension sufficient to reduce wastewater flow backpressure into the water discharge hose of the washing machine;
b) a quill injector within the first chamber, having an input coupled to the dosing chemical input and an output centrally located in the hollow body; and
c) a static mixing chamber having a hollow body with an input coupled to the output of the first chamber at a first end, a drain output at a second end, and a plurality of baffles within the hollow body to promote mixing, the mixing chamber having a larger inside dimension than the inside dimension of the first chamber to reduce wastewater flow backpressure from the static mixing chamber to the first chamber.

2. The chemical dosing device of claim 1, further comprising a supply of dosing chemical coupled to the dosing chemical input of the first chamber.

3. The chemical dosing device of claim 2, in which the supply of dosing chemical comprises a chemical tank located to feed dosing chemical into the dosing chemical input by gravity, and in which the dosing chemical input further comprises a manual valve controlling flow through the dosing chemical input, the valve being actuated by a mechanical actuating lever inside the first chamber, such that wastewater flow through the first chamber pushes on the mechanical actuating lever, opening the manual valve, and feeding dosing chemical by gravity from the chemical tank into the first chamber through the quill injector.

4. The chemical dosing device of claim 2, in which the supply of dosing chemical comprises a chemical tank coupled by a conduit to an input of an electric pump having an output coupled to the dosing chemical input, the electric pump being actuated by a switch operated by a actuating lever inside the first chamber, such that wastewater flow through the first chamber pushes on the actuating lever, closing the switch to turn on the electric pump, feeding dosing chemical from the chemical tank into the first chamber through the quill injector.

5. The chemical dosing device of claim 4, further comprising a check valve between the output of the electric pump and the dosing chemical input.

6. The chemical dosing device of claim 4, further comprising an electric purge feature activating the electric pump to purge air from the conduit.

7. The chemical dosing device of claim 1 in which the dosing chemical is selected from the group consisting of calcium chloride, calcium hydroxide and aluminum sulfate.

8. The chemical dosing device of claim 1, further comprising a detention volume having an input coupled to the drain output of the static mixing chamber and an output coupled to a drain, for retaining wastewater for a determined period of time prior to discharge into the drain.

9. The chemical dosing device of claim 8, in which the detention volume comprises a length of hose.

10. The chemical dosing device of claim 1 in which the first chamber is a cylinder having a diameter of approximately 1 inch and the length of the first chamber is between 6 and 12 inches.

11. The chemical dosing device of claim 1, in which the length of the static mixing chamber between the input and the drain output is between 8 and 16 inches and the diameter is between 2 and 4 inches.

12. A method of treating wastewater from a water discharge hose of a washing machine coupled to an input of a chemical dosing device comprising a first chamber having a first end, a second end and a length therebetween, an input at a first end for coupling to the water discharge hose, a dosing chemical input coupled to a supply of dosing chemical, and an output, the first chamber having an inside dimension sufficient to minimize wastewater flow backpressure into the water discharge hose of the washing machine; a quill injector within the first chamber, having an input coupled to the dosing chemical input and an output centrally located in the hollow body; and a static mixing chamber having a hollow body with an input coupled to the output of the first chamber at a first end, a drain output at a second end, and a plurality of stationary baffles within the hollow body to promote mixing, the mixing chamber having a larger inside dimension than the inside dimension of the first chamber to reduce wastewater flow backpressure from the static mixing chamber to the first chamber; the method comprising the steps of:
a) detecting wastewater flow from the water discharge hose of the washing machine;
b) in response to detecting wastewater flow, supplying dosing chemical from the supply of dosing chemical into the first chamber of the device through the quill injector;
c) mixing the dosing chemical and the wastewater in the static mixing chamber; and
d) discharging treated wastewater from the output of the device.

13. The method of claim 12 in which the supply of dosing chemical comprises a chemical tank located to feed dosing chemical into the dosing chemical input through a manual valve by gravity, and the step of detecting is performed by a mechanical actuating lever inside the first chamber coupled to the manual valve, and the step of supplying comprises the actuating lever opening the manual valve, feeding dosing chemical by gravity from the chemical tank into the first chamber through the quill injector.

14. The method of claim 12, in which the supply of dosing chemical comprises a chemical tank coupled by a conduit to an input of an electric pump having an output coupled to the dosing chemical input, and the step of detecting is performed by closure of a switch operated by a actuating lever inside the first chamber, such that wastewater flow through the first chamber pushes on the actuating lever, closing the switch to turn on the electric pump, and the step of supplying comprises the electric pump feeding dosing chemical from the chemical tank into the first chamber through the quill injector.

15. The method of claim 12, further comprising the step of purging air from the conduit, comprising activating the electric pump when the chemical tank is filled after running dry.

16. The method of claim 12 in which the dosing chemical is selected from the group consisting of calcium chloride, calcium hydroxide and aluminum sulfate.

17. The method of claim 12, further comprising the step of retaining wastewater for a determined period of time prior to discharge into the drain in a detention volume having an input coupled to the drain output of the static mixing chamber and an output coupled to a drain.

18. The method of claim 12 in which in the step of supplying the dosing chemical, the dosing chemical is supplied at a rate of approximately 0.5 gallons per minute.
